(19) United States
(12) Patent Application Publication
(10) Pub. No.: US 2022/0361529 A1
(43) Pub. Date: Nov. 17, 2022

(54) Unknown

(71) Applicant: Tiernahrung Deuerer GmbH, Bretten (DE)

(72) Inventor: Hans-Jürgen Deuerer, Bretten (DE)

(21) Appl. No.: 17/740,689

(22) Filed: May 10, 2022

(30) Foreign Application Priority Data
May 12, 2021 (DE) 10 2021 112 385.2

(51) Int. Cl. A23K 30/00; A23K 40/00; A23K 10/20; A23K 10/30; A23K 10/22; A23K 20/22; A23K 20/163; A23K 50/45; B65B 55/14; B65B 25/00; B65B 19/34; B65D 75/42

(52) U.S. Cl. CPC A23K 30/00; A23K 40/00; A23K 10/20; A23K 10/30; A23K 10/22; A23K 20/22; A23K 20/163; A23K 50/45; B65B 55/14; B65B 25/001; B65B 19/34; B65D 75/42

(57) ABSTRACT

The present invention relates to a method for producing and preserving a semimoist animal feed, it being distinguished by the fact that it comprises the steps of drying and preservation by thermal treatment and pressure treatment of the nonperishable semimoist animal feed packaged in a packaging unit. In a further aspect, the present invention is directed to a thus obtainable semimoist animal feed packaged in a substantially gas-tight packaging unit having improved storage properties, especially storage stability. Lastly, sales units comprising multiple packaging units, optionally detachable from one another, containing the semimoist animal feed are provided.

The present invention relates to a method for producing and preserving a semimoist animal feed, it being distinguished by the fact that it comprises the steps of drying and preservation by thermal treatment and pressure treatment of the nonperishable semimoist animal feed packaged in a packaging unit. In a further aspect, the present invention is directed to a thus obtainable semimoist animal feed packaged in a substantially gas-tight packaging unit having improved storage properties, especially storage stability. Lastly, sales units comprising multiple packaging units, optionally detachable from one another, containing the semimoist animal feed are provided.

### PRIOR ART

Animal feeds are required and offered as fresh feed but also as storable animal feed. This applies not only to dry animal feed, but also to semimoist and moist animal feed. However, preservation for improved storage is difficult especially for semimoist and moist animal feed because storage stability is reduced owing to the moisture content present.

In the animal feed sector, a distinction is made between i) wet feed having a moisture content of 50% by weight or greater, ii) semimoist products having a moisture content of below 50% by weight to above 15% by weight, and iii) dry products having a moisture content of up to 15% by weight.

Wet feed is defined as feed having moisture contents of 50% by weight or greater and is usually produced by combining, comminution and mixing of the components, the components comprising meat components and dry ingredients, but also hydrocolloids, minerals, vitamins, etc. After comminution with the aid of a bowl cutter, for example, a homogeneous mass referred to as emulsion is obtained. Such a mass is, for example, shaped in a so-called steam tunnel to form strands and then filled with a liquid component, for example a sauce, etc. The emulsion can also be directly introduced into the packaging. Packaging such as bowls, cans and pouches is filled with these emulsion mixtures for wet feed with or without a pretreatment, for example in a steam tunnel, and with or without sauce, and said emulsion mixtures are sealed either thermally or ultrasonically such that they are absolutely tightly sealed. Such sealed packaging is placed into an autoclave for sterilization and sterilized within temperature ranges between 125° C. and 130° C. with various holding times. This sterilization to improve shelf life involves killing pathogens, such as salmonellae, aerobic pathogens and other anaerobic pathogens; as a result, the recipe usually does not contain preservatives, such as potassium sorbate. During this sterilization, there is a change in structure, sliceability, taste, etc. Sterilization is thus a necessary method step for wet feed in order to obtain the end product. Furthermore, said sterilization requires the presence of hermetically sealed packaging, such as tins or bowls, so that the moisture content of the wet feed of above 50% by weight remains unchanged. Without this requirement, it is impossible to bring a moist feed onto the market, and the packaging would inflate in the absence of sterilization and burst after 24 hours at the latest.

Semimoist animal feeds or semimoist foods having moisture contents of below 50% by weight to above 15% by weight are likewise provided as a homogeneous mass, the emulsion, containing the ingredients. Besides the meat components, said ingredients usually contain dry ingredients and further auxiliaries, such as hydrocolloids, minerals and vitamins, as well as preservatives and antioxidants in order to increase shelf life.

In customary production methods, the emulsion obtained is shaped and is brought to the desired moisture content, usually at temperatures of between 80° C. and 90° C., in a drying oven. These predried products are then appropriately brought to the desired product sizes and packaged using film. Such films are sealed according to the customary methods and are the sellable product having the desired properties, such as sliceability, structure, taste, etc., of the end product. The problems that are known for wet feed, for example the inflation and bursting of this sellable packaging thus present, do not exist.

Customary semimoist products as currently on the market have moisture contents of below 30% by weight, usually within the range between 25% by weight and 30% by weight. Especially these semimoist products lack shelf life and storage stability. They are usually storable and nonperishable for just a few months before they perish. In order to increase shelf life, large quantities of preservatives are therefore commonly added. However, the addition of preservatives is not desirable for many reasons and, in some cases, preservatives are incompatible for animals, such as sodium nitrite for dogs.

Cats and dogs are carnivorous species which mainly feed on meat, especially on prey, in the wild. In addition, meat and fish, i.e. animal proteins, are vehicles with high acceptance, based on the feeding behavior of the animals. Therefore, it is sensible as regards nutrition to provide a feed which has a high meat content, optionally enriched with fish, and thus a high content of animal proteins and which can optionally comprise further ingredients at the same time. It is generally desired to provide the products, either as a main meal or in the form of snacks, as semimoist or moist meat-based feeds. Besides their property as food, said snacks also allow further functions to be undertaken, such as tooth care; however, they can also be used for the purposes of rearing and training.

It is hitherto the prior art that such nonperishable semimoist animal feeds have a high content of preservatives or other additives, such as phosphates, etc., which allow not only the preservation but also an appropriately visual preparation of the product, such as an appropriate redness of the meat, etc. Such semimoist animal feeds made nonperishable, such as snacks, commonly have a proportion of preservatives of usually 0.1% to 1% of the total weight; use is made here of, for example, potassium sorbate or other known preservatives, which then allow a minimum shelf life of the product of from 15 to 18 months.

It should be noted here that, according to the additives authorized for the feed industry as preservatives, substances such as potassium sorbate, sodium bisulfite, or potassium diformate and other agents have been described as preservatives; see the Futtermittelverordnung [Feed regulation] in the version currently in force; sodium chloride or other halogen salts by contrast are regarded as minerals according to the Futtermittelrecht [Feed law].

Besides the appropriate acceptance of the feeds, for example in the form of snacks or sticks, with an appropriately attractive visual impression, a major aspect is preservation and minimum shelf life. Here, there are increasing demands from consumers that the origin of the ingredients be as natural as possible and that low levels of ingredients such as preservatives, etc., be present or, if possible, none at all.

It is therefore an object of the present invention to provide semimoist animal feeds which have a long shelf life, said semimoist animal feeds having been produced essentially without additives, especially without addition of preservatives.

### DESCRIPTION OF THE INVENTION

It became apparent that, surprisingly, a combination of known technical methods allow the provision of semimoist animal feeds having excellent properties as regards minimum shelf life and having an attractive visual impression, said animal feeds having a high proportion of meat and animal by-products in one embodiment, and the animal feeds according to the invention having especially a low proportion of preservatives, in particular no preservatives, in one embodiment.

In a first aspect, what is provided is a method for producing and preserving a semimoist animal feed, comprising the steps of:
a. provision of an animal-feed precursor;
b. comminution and shaping of the animal-feed precursor and optionally drying of the shaped animal-feed precursor in order to obtain a semimoist animal feed having a moisture content of >15% by weight and <50% by weight;
c. packaging of the semimoist animal feed in a substantially gas-tight packaging unit;
d. preservation by thermal treatment and optionally pressure treatment in order to obtain a nonperishable semimoist animal feed present in a packaging unit.

In one embodiment, the animal-feed precursor is an animal-feed precursor comprising at least 50% meat or animal by-products, such as at least 70% by weight, for example at least 80% by weight, at least 90% by weight, at least 95% by weight, such as at least 98% by weight. In another embodiment, the animal-feed precursor is an animal-feed precursor substantially consisting of vegetables or vegetable constituents. This means that the proportions of vegetables and vegetable constituents are at least 50% by weight, such as at least 70% by weight, for example at least 80% by weight, at least 90% by weight, at least 95% by weight, such as at least 98% by weight.

In a further embodiment, the animal-feed precursor is an animal-feed precursor based on insects or insect constituents. This means that a substantial proportion of the animal-feed precursor, such as at least 50% by weight, for example 70% by weight, 80% by weight, such as at least 90% by weight, at least 95% by weight, for example at least 98% by weight, consists of insects or insect constituents.

In a further embodiment, the animal-feed precursor is an animal-feed precursor based on fish or fish products. This means that a substantial proportion of the animal-feed precursor, such as at least 50% by weight, for example 70% by weight, 80% by weight, such as at least 90% by weight, at least 95% by weight, for example at least 98% by weight, consists of fish or fish products.

In one embodiment, the animal-feed precursor can be an animal-feed precursor substantially made up of sources of protein, fat and carbohydrates, like the ones mentioned above alone or in combination. In one embodiment, the animal-feed precursor is an animal-feed precursor substantially consisting of nonanimal sources of protein, fat or carbohydrates.

According to the invention, the animal-feed precursor can also be a mixture of meat and animal by-products, fish and fish products, vegetables and/or insects and/or constituents of these stated products.

This method is especially a method in which shelf life is increased and the visual impression of the product is improved as a result of heat sterilization, for example by steam or water, of a dried semimoist animal feed packaged in a substantially gas-tight packaging unit prior to heat sterilization.

In a further aspect, what is provided is said semimoist animal feed, packaged in a substantially gas-tight packaging unit, obtainable in accordance with the method according to the invention. It is distinguished by an improved minimum shelf life of, for example, at least 18 months, such as at least 20 months, and is, for example, present in the form of a stick, such as a chew stick.

Accordingly, packaging units containing substantially gas-tight, packaged, semimoist animal feeds, for example in the form of a stick, are provided. Furthermore, sales units comprising multiple connected packaging units, optionally detachable from one another, are described, said packaging units comprising individual semimoist animal-feed products obtainable according to the present invention.

A “semimoist animal feed” is understood to mean an animal feed having a moisture content of >15% by weight to <50% by weight of water, based on the total weight of the animal feed. Moisture is usually determined by means of drying at 103° C. as described in Regulation (EC) No 152/2009, annex III, A, last amended 2017-05. “Meat” is understood to mean all meat parts of slaughtered warm-blooded land animals, fresh or made nonperishable by a suitable method, and also products obtained from animal feed processing, and processed carcasses. Unless otherwise stated, the expression “meat” encompasses both meat and animal by-products.

“Vegetables” are presently understood to mean that the entire vegetable or parts of the vegetable is/are used as product. Vegetables are usually processed, i.e. comminuted, for example pulverized or comminuted in a similar manner. Vegetables can contain one vegetable variety or can comprise a multiplicity of different vegetables. Vegetables include individual constituents of a vegetable, for example, in the case of peas, the corresponding peapods including the peas or just the peas. The same applies to other vegetables.

In one embodiment, the vegetables are supplied in solid form, for example in pulverized, granulated or freeze-dried form or the like. The expression “vegetables” also covers corresponding dry powders or purified forms or extracts and concentrates of vegetables, such as starch or protein or the like.

“Insects” are presently understood to mean insects or constituents of insects. A mixture of different species of insects or insect constituents can be used. Said constituents include purified constituents, such as proteins or starch from insects. These precursors are usually provided in solid form, for example pulverized, granulated or freeze-dried form, optionally already comminuted.

The starting materials can be used in fully or partially frozen form, for example frozen or fresh meat can be mixed such that a cooled mixture results. However, work can be carried out solely with frozen starting material and nonfrozen starting material.

Alternatively, the animal-feed precursor can be an animal-feed precursor comprising an appropriate combination of sources of protein, fat and/or carbohydrates. Said sources can be of animal (including fish) or plant origin, including insect sources.

In one embodiment, the animal-feed precursor is an animal-feed precursor consisting of at least 50% by weight, such as at least 70% by weight, at least 80% by weight, at least 90% by weight, such as at least 93% by weight, for example at least 95% by weight, such as at least 97% by weight, for example at least 98% by weight of said appropriate animal-feed precursor.

The method according to the invention is a method comprising provision of a precursor for production of the animal feed. It comprises at least 50% by weight, such as at least 70% by weight, at least 80% by weight, such as at least 90% by weight of meat, fish, vegetables or insects as the main component. Said meat, optionally admixed with further constituents, is then comminuted and shaped. Comminution and shaping can be effected according to known methods. For example, comminution is effected by means of a bowl cutter, as described in EP 3 145 323 B1 for example, or by means of an emulsifier. In addition to the meat, the animal-feed precursor can further comprise starch, flavoring agents and additives and also other dry ingredients such as pea powder or pea starch, but also table salt, prior to comminution, for example by cutting or ultrafine comminution. In a preferred embodiment, no preservatives are added.

It should be emphasized here once again that preservatives are understood to mean substances referred to as preserving substances according to the Futtermittelverordnung [Feed regulation]. Minerals, such as sodium chloride, are not preservatives that are defined in the animal-feed sector.

In one embodiment, an emulsion of the precursor is formed from the stated ingredients upon comminution and said emulsion is then shaped, for example on a grating. Shaping can be effected according to known methods.

In one embodiment, no application of heat is carried out prior to shaping. The expression “application of heat” is presently understood to mean that no heat is supplied to the precursor before or during shaping or said heat is generated by pressure. The shaping takes place at temperatures of from 1° C. to 30° C., for example 15° C. to 25° C.

“Cutting” or “bowl cutter” is presently understood to mean that the constituents present in the bowl cutter are finely and ultrafinely comminuted. This means that the shape size distribution is within the range from 10 mm to 0.1 mm or smaller. Cutting is distinguished by a process in which as many cells as possible are subjected to damage to the cell membranes in order to obtain a fine and uniform material. Appropriate “bowl cutters” are known to a person skilled in the art; the blades are, for example, operated at a speed of 60 revolutions per min, for example at least 200 revolutions per min, for example 2800 revolutions per min. At least partial denaturation of the proteins takes place during cutting. What is usually obtained as a result is an emulsion.

Ultrafine comminution is presently understood to mean that the constituents present are finely and ultrafinely comminuted. This means that the shape size distribution is within the range from 10 mm to 0.1 mm or smaller. Ultrafine comminution is distinguished by a process in which the product is first precomminuted. The ultrafine comminution is, for example, effected by means of a separate cutting system. The cutting set consists, for example, of a blade head rotating with a shaft and an exchangeable perforated plate fixed in the cutting housing. The degree of fineness is substantially determined by the holes of the perforated plate, through which the mass is pressed.

Drying, if necessary, can be effected according to known methods. Drying is usually effected at elevated temperatures, such as at above 50° C., for example at 70° C. or greater, for example within the range of from 70° C. to 100° C., for example 80° C. to 90° C. The desired moisture content is set at the same time. Said moisture content is within the moisture content of a semimoist animal feed, namely within the range from >15% by weight to below 50% by weight. If the comminuted and shaped animal-feed precursor should already have this moisture content, extensive drying is not necessary. Accordingly, the drying step is optional. The appropriate customary ways of drying such animal-feed precursors for provision of semimoist animal feeds are known to a person skilled in the art.

Comminution, shaping and optionally drying can be effected such that drying is effected if the semimoist animal feed should still have a moisture content of greater than 50% by weight after comminution and shaping. The animal feed can be portioned before drying or after drying. This mean that portioning can be effected after shaping, so that these portioned shaped animal feeds are then optionally dried in order to obtain the semimoist animal feed. Alternatively, shaping can be followed by drying, if necessary, with subsequent portioning.

The portioned, semimoist animal feed is then placed into a packaging unit, i.e. packaged, and said packaging unit is substantially gas-tightly sealed after the animal feed has been introduced.

In one embodiment, the air present in the packaging unit is replaced with a protective gas, such as N₂, CO₂ or a mixture of N₂ and CO₂ or some other combination of the stated gases, to a substantial extent, such as with a percentage of at least 80% or at least 90%, in order to avoid oxidation.

The packaging unit is sealed. This thus sealed packaging unit is an already sellable product having the desired properties such as taste, sliceability and structure. According to the invention, this sealed, substantially gas-tight packaging unit having a semimoist animal feed present therein is then subjected to a preservation process by thermal treatment. In one embodiment, said thermal treatment can comprise a simultaneous pressure treatment.

The thus obtained semimoist animal feed present in the packaging unit has a long shelf life.

The desired longer shelf life is possible as a result of further treatment of the semimoist animal feed in its packaging, which animal feed is already sellable and has the desired taste, structure and sliceability, by means of additional thermal treatment and optionally pressure treatment. Sterilization allows extension of shelf life even in embodiments in which no preservatives are present in the semimoist animal feed. In particular, it became apparent that, surprisingly, said additional thermal treatment optionally with pressure treatment, especially sterilization by autoclaving, does not adversely affect the properties of the sales product in the sealed packaging unit; structure, taste and sliceability remain unchanged. According to the invention, it is possible to provide semimoist foods having an extended shelf life in the presence of low levels of or the absence of preservatives, as defined according to the Futtermittelverordnung [Feed regulation].

In one embodiment, the step of preservation is a step involving heat sterilization by steam or water. Suitable ways of heat sterilization are known to a person skilled in the art. Heat sterilization involves treatment in an autoclave with thermal treatment with elevated pressure, which can also be referred to as counter-pressure.

In one embodiment, the moisture content of the semimoist animal feed is a moisture content of from at least 30% by weight to below 50% by weight, especially 35% by weight to 45% by weight. In one embodiment, the moisture content of the semimoist animal feed in the packaging unit after preservation is at least 40% by weight, whereas previous semimoist animal feeds produced substantially without preservatives have moisture contents of from 27% to 30% by weight. Relatively high moisture contents in semimoist animal feeds without preservatives were hitherto not possible without substantially limiting the shelf life of these semimoist products, and so the method according to the invention accordingly allows the provision of semimoist animal feeds substantially free of preservatives and having a long shelf life. In one aspect, said shelf life is a shelf life of a least 15 months, such as at least 18 months, especially at least 20 months, such as especially 24 months or longer.

In one embodiment, the method according to the invention is a method in which the animal-feed precursor has a high proportion of meat, the proportion of meat and animal by-products in one embodiment being at least 50% by weight, such as at least 70% by weight, at least 80% by weight, at least 90% by weight, at least 95% by weight, such as at least 97% by weight, based on the total amount of precursor.

The method according to the invention makes it possible, inter alia, to increase the proportion of sources of protein, fat and/or carbohydrates, for example of meat and animal by-products, in the semimoist animal feed without reducing its shelf life.

In the semimoist animal feed obtainable according to the invention, the proportion of meat, fish, vegetables or insects is a proportion of at least 50% by weight, such as at least 70% by weight, at least 80% by weight, at least 90% by weight, such as at least 95% by weight, for example at least 97% by weight, according to the constituents present in the animal-feed precursor.

In a further aspect, the method is a method in which less than 1% by weight of salt, such as less than 0.8% by weight of salt, is added the precursor for production of the semimoist animal feed. The salt is especially a sodium chloride. These salts comprise especially no preservatives and especially no nitrite salts, as otherwise used for preservation and reddening of meat.

Instead, the salts added, especially sodium chloride, are minerals as defined according to the Futtermittelverordnung [Feed regulation].

Besides said meat, the animal-feed precursor contains especially no nitrite salt. However, further ingredients, such as flavoring agents, starch and table salt, can be present.

Furthermore, additives customary in the feed industry can be added, especially flavors, natural and synthetic coloring agents, inactive yeasts or yeast extracts, plant extracts and concentrates, especially vegetable extracts (especially when the main constituent is meat, fish or insects). Furthermore, in one embodiment, functional ingredients, for example probiotics, can be added; these are understood to mean, inter alia, vitamins and minerals, omega-3 fatty acids, probiotic fibers and probiotic microorganisms.

The method according to the invention comprising its steps of optional drying and additional preservation by subjecting the animal feed in the substantially gas-tight packaging unit to heat and optionally pressure includes the optionally necessary step of drying to the desired moisture content, namely as per step b) as stated above, this drying being drying at a temperature of from 70° C. to 95° C., such as 80° C. to 90° C., and the drying period being sufficiently long in order to obtain the desired moisture content. Customary drying periods are: 1-8 hours depending on the recipe, weight and diameter of the product.

Especially in one embodiment, the method according to the invention is a method in which the semimoist animal feed is preserved in such a manner in step d) which a thermal treatment with elevated pressure, such as steam sterilization, is subjected. Said elevated pressure or counter-pressure having a pressure above standard pressure is, for example, a pressure of from 0.3 bar to 5 bar, such as 2.5 bar to 4.5 bar.

The step of preservation by thermal treatment and optionally pressure treatment, especially by steam sterilization, for example in an autoclave, which step is according to the invention, makes it possible to improve the visual impression of the semimoist animal-feed product obtained. Especially the visually attractive redness of the product is possible, and so the appearance of the product is made attractive and corresponds to the appearance of fresh meat. It became apparent that, owing to this last step of preservation by means of especially heat sterilization, such as steam sterilization, the color of the otherwise gray product is converted into a visually attractive red tone, such as a red-brown tone.

In one embodiment, the method according to the invention relates to a method for producing and preserving a semimoist animal feed, comprising the steps of
a. provision of an animal-feed precursor, for example an animal-feed precursor comprising at least 50% by weight, such as at least 70% by weight, at least 80% by weight, at least 95% by weight of meat and animal by-products, fish and fish products and/or vegetables and/or insects, not more than 1% by weight of salt, especially not more than 1% by weight of table salt, starch, especially pea starch;
b. comminution, especially cutting, and shaping of an animal-feed precursor and optionally drying of the shaped animal-feed precursor in order to obtain a semimoist animal feed having a moisture content of from 30% by weight to 45% by weight;
c. packaging of the semimoist animal feed having a moisture content of between 30% by weight to 45% by weight into a substantially gas-tight packaging unit;
d. steam sterilization of the semimoist animal feed, packaged in the substantially gas-tight packaging unit, in order to obtain a nonperishable semimoist animal feed.

In a further aspect, a semimoist animal feed obtainable using the method according to the invention is provided. Said semimoist animal feed is a semimoist animal feed present in a substantially gas-tight packaging unit, obtainable using the method according to the invention.

The semimoist animal feed according to the invention is distinguished by the fact that it has a shelf life of at least 15 months, such as at least 18 months, and at least 20 months, such as at least 24 months. In a further aspect, the semimoist animal feed according to the invention in one embodiment having meat as major animal-feed precursor is a semimoist animal feed having a fat content of below 10% by weight in the semimoist animal feed. Unlike the previous products on the market containing meat, which usually have a fat content of from 18% by weight to 22% by weight, the method according to the invention allows the provision of semimoist animal feeds according to the invention having a fat content of 10% by weight or lower.

In a further embodiment, the semimoist animal feed according to the invention, obtainable in accordance with the method according to the invention, has an ash content of below 5% by weight. The ash content is, for example, of a range from 3% by weight to 5% by weight. This allows the provision of semimoist animal feeds having particularly favorable properties as regards nutrition for carnivorous animals, said semimoist animal feeds having a particularly long shelf life in accordance with the invention.

The thermal and/or pressure treatment can alternatively also be a radiation treatment, for example a radiowave treatment. When using appropriate electromagnetic radiation for preservation, the packaging material of the packaging unit must accordingly be taken into account.

In one embodiment, the semimoist animal feed according to the invention is in the form of a stick, especially a chew stick.

In one embodiment, the packaging unit for the semimoist animal feed is in the form of a tubular bag. The material of the packaging unit is a material which provides a substantially gas-tight seal, and so, during steam sterilization for example, no moisture penetrates into the interior of the packaging unit and conversely no moisture leaks from the packaging unit.

The expression “substantially gas-tight” or “gas-tight” is presently understood to mean that oxygen permeability and water vapor permeability is low. For example, oxygen permeability is >0.1 cm³/m²*d*bar, determined in accordance with DIN 53380 or ISO 2556 at 23° C. and 50% room humidity. In the case of water vapor permeability, when this sealing is substantially gas-tight, water vapor permeability is >0.1 g/m³*d, determined for example in accordance with DIN 53122/ISO 1195 at 23° C. and 85% room humidity.

Appropriate methods for determining oxygen and water vapor permeability and suitable gas-tight materials are known to a person skilled in the art.

Furthermore, the present invention relates to sales units of at least two packaging units, it being possible for said packaging units to be detachably connected to one another. Said packaging units are, for example, detachable via weakened regions, such as a perforation or appropriate changes in the interconnected materials, and so individual packaging units having a semimoist animal feed contained therein can be removed. Said sales units comprising at least two packaging units detachably connected to one another allow the sale of a multiplicity of individually packaged semimoist animal feeds. Because of the longer shelf life, appropriate sales units comprising a multiplicity of at least two, such as three, four, five, six, seven, eight or at least ten packaging units, containing the semimoist animal feed according to the invention, are possible.

Alternatively, the semimoist animal feed according to the invention in the packaging unit present as a sales unit can also be combined with other feed products and, for example, be offered as mixed feeds. In one embodiment, the semimoist animal feed is especially a semimoist animal feed for dogs, cats or koi. Said semimoist animal feeds can accordingly be present as a complete meal or in the form of snacks.

In what follows, the invention will be more particularly elucidated on the basis of an exemplary embodiment which merely serves to illustrate one possible embodiment and is not intended to restrict the scope of protection.

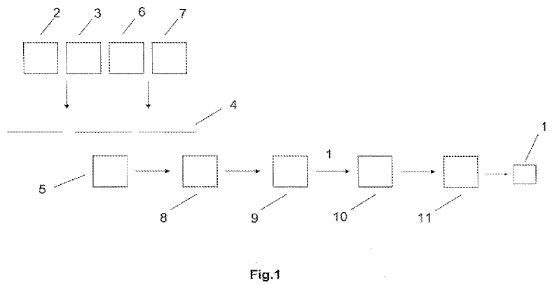

FIG. 1 schematically depicts the production of a semimoist animal feed according to the invention based on a meat product in the present case.

In a first step, animal-feed precursors comprising 95% by weight of meat and animal by-products (insect products, fish products or plant products are alternatively also conceivable) containing not more than 1% by weight of salt, especially not more than 1% by weight of table salt, and additionally further constituents, such as starch or pea starch and pea powder, are placed into a bowl cutter 5 as comminution means. These additives are, for example, present in the containers 2 and optionally 3 if separate containers are intended, for example for meat from different animal species, and are fed to the local bowl cutter 5. Furthermore, further containers (6,7) contain further constituents, such as vegetables, etc., which can be added to the meat additives. Further containers, for example for salts, etc., the contents of which can reach the bowl cutter 5 via intakes, are not depicted in the FIGURE.

According to the invention, it is especially not intended to add preservatives at this moment or at any other moment in production.

Optionally, a perforated disk 4, for example, can be placed upstream of the bowl cutter in order to allow comminution of the meat additives.

After comminution, the emulsion thus obtained is fed to the former 8 for shaping. From the former 8, the shaped animal-feed precursor is, if necessary, fed to the dryer 9, where it is dried to a moisture content of, for example, 30% to 45% by weight in order to obtain a semimoist animal feed.

After drying or alternatively after shaping, the semimoist animal feed is fed to a packaging machine/packing machine 10, in which the semimoist animal feed is packaged into substantially gas-tight packaging. After packaging, this packaging unit containing the semimoist animal feed is fed to a preservation process, for example by steam sterilization 11, in order to obtain lastly the packaged nonperishable semimoist animal feed 1.

During steam sterilization, the sterilization is, for example, carried out at a counter-pressure of from 0.3 to 5 bar, such as 2.5 to 4 bar, above standard pressure.

The end product thus obtained has an excellent shelf life of from at least 24 months to 36 months, there being no preservatives contained in the product.

### LIST OF REFERENCE SIGNS

1 Packaging unit containing a semimoist animal feed
2 Container
3 Container
4 Perforated disk
5 Bowl cutter
6 Container
7 Container
8 Former
9 Dryer
10 Packing machine
11 Steam sterilization

1. A method for producing and preserving a semimoist animal feed, comprising the steps of:
providing an animal-feed precursor;
comminuting and shaping of the animal-feed precursor to form a shaped animal-feed precursor, and optionally drying the shaped animal-feed precursor;
obtaining a semimoist animal feed having a moisture content of >15% by weight and <50% by weight from the shaped animal-feed precursor;
packaging the semimoist animal feed in a substantially gas-tight packaging unit; and
preserving the semimoist animal feed by thermal treatment, and optionally pressure treatment, to obtain a nonperishable semimoist animal feed present in a packaging unit.

2. The method for producing and preserving a semimoist animal feed according to claim 1, wherein the step of preserving includes steam sterilization.

3. The method for producing and preserving a semimoist animal feed according to claim 1 wherein the step of providing the animal-feed precursor provides the animal-feed precursor with at least 50% by weight of meat and animal by-products, or provides the animal-feed precursor with at least 50% by weight vegetables and/or vegetable constituents, or provides the animal-feed precursor with at least 50% by weight insects and/or insect constituents, or provides the animal-feed precursor with at least 50% by weight fish and/or fish by-products.

4. The method for producing and preserving a semimoist animal feed of claim 1, wherein the step of providing the animal-feed precursor comprises providing an animal-feed precursor containing less than 1% by weight of salt.

5. The method for producing and preserving a semimoist animal feed according to claim 1 wherein drying is performed on the shaped animal-feed precursor to a moisture content of from at least 30% by weight to below 50% by weight.

6. The method for producing and preserving a semimoist animal feed according to claim 1 wherein the animal-feed precursor provided in the providing step does not comprise a nitrite salt.

7. The method for producing and preserving a semimoist animal feed according to claim 1 wherein drying is performed on the shaped animal-feed precursor at a temperature of from 70° C. to 95° C.

8. The method for producing and preserving a semimoist animal feed according to claim 1 wherein the preserving step comprises thermal treatment with elevated pressure of from 0.3 bar to 5 bar, such as 3.5 bar to 4 bar.

9. The method for producing and preserving a semimoist animal feed according to claim 1 wherein
the step of providing the animal-feed precursor provides at least 50% by weight of meat and animal by-products, not more than 1% by weight of salt, starch, and optionally no preservatives;
the step of comminuting and shaping of the animal-feed precursor and optionally drying of the shaped animal-feed precursor obtains a semimoist animal feed having a moisture content of >15% by weight and <50% by weight;
the step of packaging of the semimoist animal feed into a substantially gas-tight packaging unit is performed when the semimoist animal feed has a moisture content between 30% by weight and 45% by weight; and
the step of preserving is performed with steam sterilization of the semimoist animal feed, packaged in the substantially gas-tight packaging unit, in order to obtain the nonperishable semimoist animal feed.

10. A semimoist animal feed in a substantially gas-tight packaging unit made by the process of claim 1.

11. The semimoist animal feed according to claim 10, wherein the semimoist animal feed it has a shelf life of at least 15 months.

12. The semimoist animal feed according to claim 10 wherein the semimoist animal feed has a fat content of below 10% by weight and/or an ash content of below 5% by weight.

13. The semimoist animal feed according to claim 10 wherein the semimoist animal feed is packaged in tubular bag packaging and/or the semimoist animal feed is formed as a stick.

14. The semimoist animal feed according to claim 10, wherein an individual semimoist animal feed product is present per packaging unit.

15. A sales unit comprising multiple packaging units, optionally detachable from one another, each of the packaging units containing the semimoist animal feed of claim 10.

16. The method for producing and preserving a semimoist animal feed according to claim 2, wherein the steam sterilization is performed in an autoclave under thermal treatment with elevated pressure.

17. The semimoist animal feed according to claim 10 wherein the semimoist animal feed contains less than 1% by weight of salt.
